(19) United States
(12) Patent Application Publication
(10) Pub. No.: US 2020/0387668 A1
(43) Pub. Date: Dec. 10, 2020

(54) TEXT ANALYSIS METHOD, NON-TRANSITORY COMPUTER-READABLE RECORDING MEDIUM FOR STORING TEXT ANALYSIS PROGRAM, AND TEXT ANALYSIS SYSTEM

(71) Applicant: HITACHI, LTD., Tokyo (JP)

(72) Inventors: Kenichi YOKOTE, Tokyo (JP); Makoto IWAYAMA, Tokyo (JP)

(73) Assignee: HITACHI, LTD.

(21) Appl. No.: 16/831,383

(22) Filed: Mar. 26, 2020

(30) Foreign Application Priority Data
Jun. 6, 2019 (JP) 2019-106584

(51) Int. Cl. G06F 40/247; G06F 16/36

(52) U.S. Cl. CPC G06F 40/247; G06F 16/374

(57) ABSTRACT

Pieces of text having a correspondence relationship are searched with precision. By a text analysis method performed by a text analysis system, constitutional units of text obtained by executing element decomposition processing are generated from each of first text and second text. Similarity of each constitutional unit pair between the constitutional units of the first text and the constitutional units of the second text is measured. Whether each constitutional unit pair is either a synonym with the similarity equal to or more than a specified value or a related word with the similarity less than the specified value is judged. A related word applicable area to which the related word is to be applied from the second text is identified on the basis of the judged synonym. A correspondence relationship between the related word applicable area and the first text is judged on the basis of the judged related word.

### CROSS REFERENCES TO RELATED APPLICATION

This application claims priority based on Japanese patent applications, No. 2019-106584 filed on Jun. 6, 2019, the entire contents of which are incorporated herein by reference.

### BACKGROUND

The present invention generally relates to a text analysis method, a text analysis program, and a text analysis system.

For example, when there are two documents which constitute a pair such as a newspaper article and its corresponding post on an SNS (Social Networking Service), there is technology that estimates based on which sentence of the former text each sentence of the latter text was written. If this technology is used, for example, information corresponding to the post on the SNS can be collected from the newspaper article. Such information will be useful to check the background of the posted content and make a decision whether or not to trust the posted content.

The correspondence relationship between sentences is estimated by checking, for example, whether a word included in one sentence is also included in the other sentence or not. For example, PTL 1 and PTL 2 disclose methods for estimating the correspondence relationship between words in two sentences.

### CITATION LIST

### Patent Literature

PTL 1: Japanese Patent Application Laid-Open (Kokai) Publication No. 2019-16074
PTL2: Japanese Patent Application Laid-Open (Kokai) Publication No. 2012-14245

### SUMMARY

For example, regarding two sentences stating that “victims should be helped” and “victims should be saved,” the words “helped” and “saved” have a correspondence relationship. Accordingly, as a method for estimating the correspondence relationship between words which are not completely matched, there is a method for measuring similarity between the words, extracting another word from the original word, and judging that there is the correspondence relationship if the relevant word completely matches the other word. In this example, by extracting “saved” from “helped” of the “victims should be helped” and evaluating a complete match between the extracted word and “saved” of the “victims should be saved,” the correspondence relationship between “helped” and “saved” is evaluated.

There is a method of using ontology and word distributed representations to measure the similarity between words. Under this circumstance, another word(s) which is evaluated, when extracted, as having high similarity with the original word is defined as a “synonym(s).” Also, another word(s) which is evaluated, when extracted, as having low similarity with the original word is defined as a “related word(s).” There is a case of the related word in, for example, sentences stating that “victims are suffering” and “victims should be saved,” where the two sentences having the correspondence relationship can be estimated although the similarity between the words is low. On the other hand, the low similarity between words does not necessarily mean that the relevant two sentences, such as “victims are suffering” and “diabetic patients are suffering”, have the correspondence relationship.

Furthermore, a related word(s) which is not appropriate as an element(s) to estimate the correspondence relationship is defined as a “noise.” In the above-mentioned example, the “diabetic patients” extracted as the related words from the “victims” are the noises. Many of the related words are noises; and if such noises are used when searching sentences having the correspondence relationship, they have a large impact on the precision degradation rather than the effect of improving the precision.

The present invention was devised in consideration of the above-described circumstances and it is one object of the invention to search pieces of text having the correspondence relationship with good precision.

In order to solve the above-described problem, provided as one means for achieving the one object according to the present invention is a text analysis method performed by a text analysis system includes: a measurement step of generating constitutional units of text obtained from each of first text and second text by executing element decomposition processing, and measuring similarity of each constitutional unit pair between the constitutional units of the first text and the constitutional units of the second text; a synonym or related-word judgment step of judging whether each constitutional unit pair is either a synonym with the similarity equal to or more than a specified value or a related word with the similarity less than the specified value; an identification step of identifying a related word applicable area to which the related word is to be applied from the second text, on the basis of the synonym judged by the synonym or related-word judgment step; and a correspondence relationship judgment step of judging a correspondence relationship between the related word applicable area and the first text on the basis of the related word judged by the synonym or related-word judgment step.

According to the present invention, for example, pieces of text having the correspondence relationship can be searched with good precision. The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a block diagram of a computer that implements a text analysis system according to an embodiment;

FIG. 2 is a block diagram illustrating a functional configuration of the text analysis system;

FIG. 3 is a diagram illustrating a configuration example of data for a word similarity DB;

FIG. 4 is a diagram illustrating a configuration example of data for a synonym DB; FIG. 5 is a diagram illustrating a configuration example of data for a related word DB; FIG. 6 is a diagram illustrating a configuration example of data for a category information DB;

FIG. 7 is a diagram illustrating a configuration example of data for a related word applicable area DB;

FIG. 8 is a flowchart illustrating the entire processing sequence of the text analysis system;

FIG. 9 is a flowchart illustrating a word similarity measurement processing sequence;

FIG. 10 is a flowchart illustrating a synonym judgment processing sequence;

FIG. 11 is a flowchart illustrating a related word judgment processing sequence;

FIG. 12 is a flowchart illustrating a category information extraction processing sequence;

FIG. 13 is a flowchart illustrating a related word applicable area identification processing sequence;

FIG. 14 is a flowchart illustrating a processing sequence for judging the correspondence relationship between first text and second text;

FIG. 15 is a diagram illustrating the result of corresponding part visualization processing; and

FIG. 16 is a diagram illustrating examples of a text ID and a word index.

### DESCRIPTION OF EMBODIMENTS

Embodiments of the present invention will be described below in detail with reference to the drawings. In this description, the same reference numeral in each drawing represents the same or similar configuration or processing. Also, any subsequent embodiment which will be explained later may include only differences from an embodiment explained earlier and the explanation of the subsequent embodiment may sometimes be omitted. Furthermore, regarding the respective embodiments, some or all of them can be combined within the scope of the technical idea of the present invention and within a consistent range.

### Embodiments

### (1) Computer for Implementing Text Analysis System

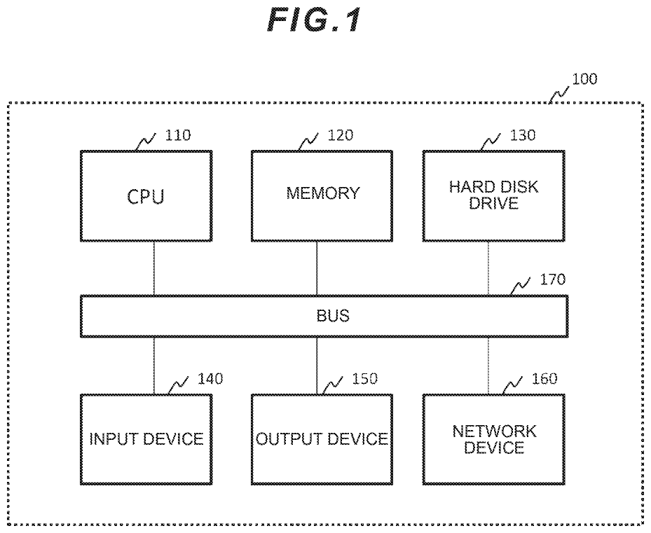

FIG. 1 is a block diagram of a computer 100 for implementing a text analysis system 200 according to an embodiment. The computer 100 includes hardware resources such as a CPU 110, a memory 120, a hard disk drive 130, an input device 140, an output device 150, and a network device 160. The text analysis system 200 is implemented by execution of a text analysis program according to this embodiment by the computer 100.

For example, the text analysis system 200 is implemented by execution of the text analysis program which is stored in a non-transitory computer readable recording medium such as the hard disk drive 130 by means of cooperation between the CPU 110 and the memory 120. The text analysis program is acquired from a distributable medium via a medium reader or is acquired from an external apparatus via a network and is executed on the text analysis system 200. However, the implementation form of the text analysis system 200 is not limited to these examples.

### (2) Functional Configuration of Text Analysis System

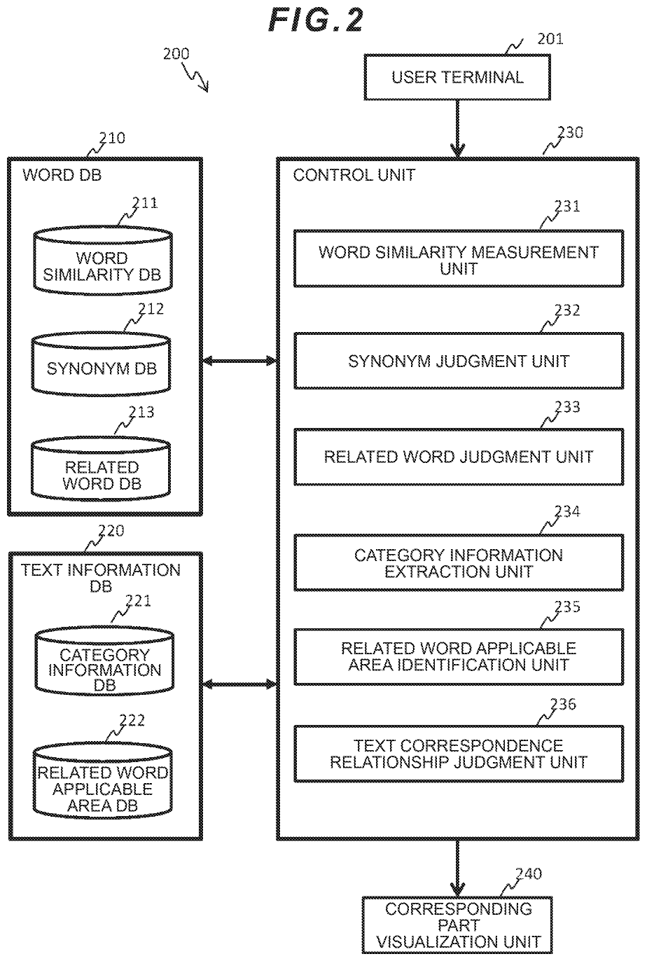

FIG. 2 is a block diagram illustrating a functional configuration of the text analysis system 200. The text analysis system 200 accepts text input of “first text” and “second text” from a user terminal 201 and generates a “synonym” and a “related word” from a “word pair” that is a pair of a first word which is a constitutional element of the “first text,” and a second word which is a constitutional element of the “second text.”

In this embodiment, constitutional elements of the text decomposed by element decomposition processing on sentences or phrases as represented by morphological analysis will be referred to as a “word(s)” as an example. However, the element decomposition processing executed on text is not limited to the morphological analysis and the constitutional elements of the text are not limited to the “words.” The “synonym” is a word of a “word pair” whose similarity is equal to or more than a specified threshold value. The “related word” is a word of a “word pair” whose similarity is less than the specified threshold value.

Moreover, the text analysis system 200 accepts input of “category information” from the user terminal 201 or generates “category information” about an area in the text which is indicated with a starting position and an ending position of the relevant word. Then, the text analysis system 200 identifies a “related word applicable area” of the “second text” on the basis of the “word,” the “synonym,” and the “category information.”

Furthermore, the text analysis system 200 judges the correspondence relationship indicating which area in the “related word applicable area” of the “second text” the “first text” corresponds to, on the basis of the “word” and the “related word” and visualizes a corresponding part.

Incidentally, the “first text” and the “second text” are not necessarily premised on having the correspondence relationship in advance. Also, the designations “first text” and “second text” are used for the sake of expediency; and the extraction of the corresponding part is not limited to the extraction of the corresponding part in the “second text” having the correspondence relationship with the “first text” and may be the extraction of a corresponding part in the “first text” having the correspondence relationship with the “second text.”

The text analysis system 200 includes a word DB 210, a text information DB 220, a control unit 230, and a corresponding part visualization unit 240 as illustrated in FIG. 2.

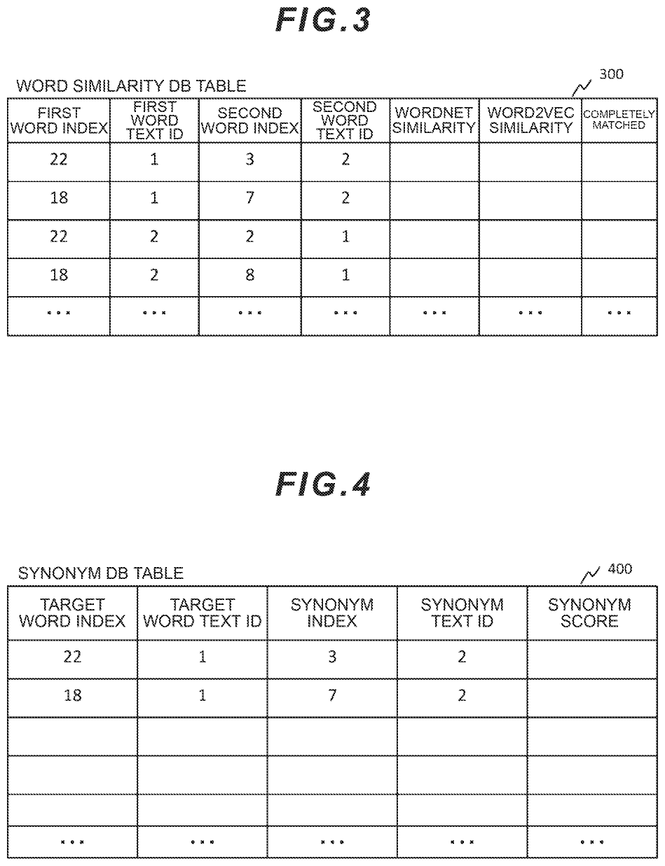

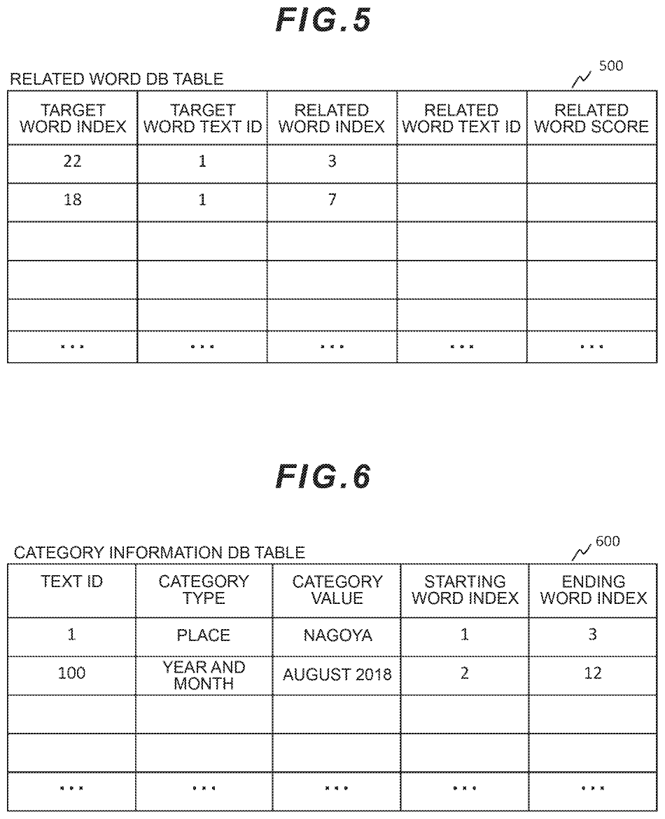

The word DB 210 stores data related to words among necessary data for identifying the related word applicable area and for judging the correspondence relationship between the first text and the second text. The word DB 210 is composed of: a word similarity DB 211 which stores similarity information about word pairs; a synonym DB 212 which stores synonym information; and a related word DB 213 which stores related word information. The detailed configuration of each piece of data will be described later with reference to FIG. 3, FIG. 4, and FIG. 5.

Incidentally, the data of the word similarity DB 211 is generated by a word similarity measurement unit 231. Also, the data of the synonym DB 212 is generated by a synonym judgment unit 232. Moreover, the data of the related word DB 213 is generated by a related word judgment unit 233. The word similarity measurement unit 231, the synonym judgment unit 232, and the related word judgment unit 233 will be described later.

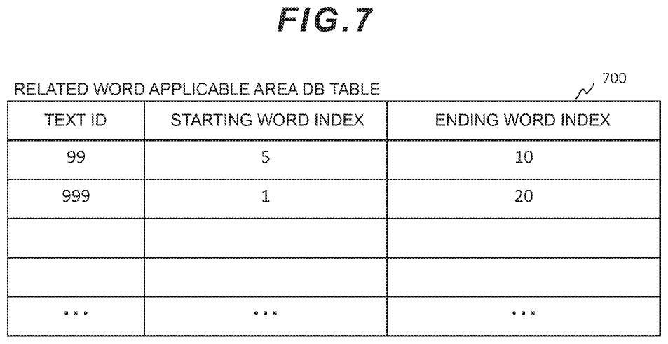

The text information DB 220 stores data related to the text among necessary data for identifying the related word applicable area and for judging the correspondence relationship between the first text and the second text. The text information DB 220 is composed of: a category information DB 221 which stores the category information of the text; and a related word applicable area DB 222 which stores the related word applicable area of the second text. The detailed configuration of each piece of data will be described later with reference to FIG. 6 and FIG. 7.

Incidentally, the data of the category information DB 221 is generated by a category information extraction unit 234. Also, the data of the related word applicable area DB 222 is generated by a related word applicable area identification unit 235. The category information extraction unit 234 and the related word applicable area identification unit 235 will be described later.

The word similarity measurement unit 231 measures the similarity with respect to all combinations of a word pair of words generated from the first text and the second text, respectively, which are input from the user terminal 201. The similarity is not limited to a measurement result by one method and measurement results by a plurality of methods may be retained. The measured similarity information is stored in the word similarity DB 211.

The synonym judgment unit 232 judges whether each word pair is in a synonym relationship or not by using the word similarity DB 211. The synonym information about the word pair which is judged as the synonym is stored in the synonym DB 212. The related word judgment unit 233 judges whether each word pair is in a related word relationship or not by using the word similarity DB 211. The related word information about the word pair judged as the related word is stored in the related word DB 213.

The category information extraction unit 234 accepts input of the category information from the user terminal 201 or extracts the category information from the first text and the second text which were input from the user terminal 201. The category information extraction unit 234 stores the category information whose input has been accepted, or the category information which has been extracted from the first text and the second text, in the category information DB 221.

The related word applicable area identification unit 235 identifies the related word applicable area in the second text by using the word similarity DB 211, the synonym DB 212, and the category information DB 221 and stores the identified related word applicable area in the related word applicable area DB 222.

The text correspondence relationship judgment unit 236 judges the correspondence relationship between the first text and the second text by using the word similarity DB 211, the related word DB 213, and the related word applicable area DB 222 and identifies a corresponding part, which corresponds to the first text, in the second text.

The corresponding part visualization unit 240 is designed to visualize the judgment result by the text correspondence relationship judgment unit 236 and the corresponding part and includes an output device such as a display for displaying a GUI.

### (3) Text ID and Word Index

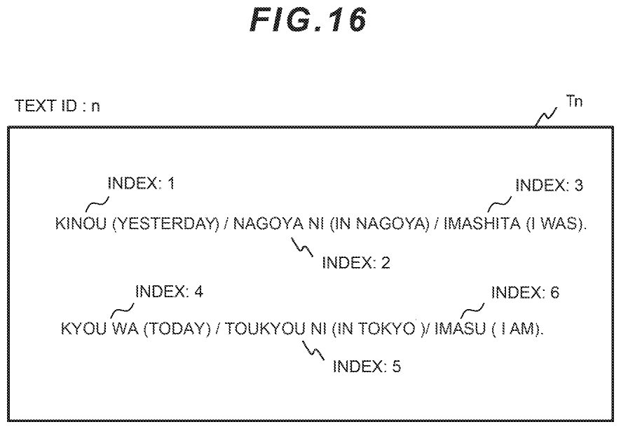

Now, before explaining the configuration of the data stored in the word similarity DB 211, the synonym DB 212, the related word DB 213, the category information DB 221, and the related word applicable area DB 222, a text ID and a word index will be explained. FIG. 16 is a diagram illustrating examples of the text ID and the word index.

Let us assume as illustrated in FIG. 16 that text TN with a “text ID: n” includes sentences stating “kinou nagoya ni imashita (I was in Nagoya yesterday); kyou wa toukyou ni imasu (I am in Tokyo today).” Let us assume that the sentences of the text Tn are decomposed, by element decomposition processing, to the following respective words: “kinou (yesterday),” “nagoya ni (in Nagoya)” “imashita (I was),” “kyou wa (today),” “toukyou ni (in Tokyo)” “imasu (I am).” Then, the “index” for each word is assigned to the relevant word, for example, “yesterday: 1,” “in Nagoya: 2,” “I was: 3,” “today: 4,” “in Tokyo: 5,” “I am: 6.”

The “text ID” uniquely identifies the relevant text. Moreover, the “index” uniquely identifies the relevant word in the text and its appearance order. Therefore, the relevant word and its appearance position can be uniquely identified by a combination of the “text ID” and the “index.”

### (4) Data Configuration of Various Kinds of DB's

Next, the configuration of the data stored in the word similarity DB 211, the synonym DB 212, the related word DB 213, the category information DB 221, and the related word applicable area DB 222 will be explained. An explanation will be provided below that the data stored in the word similarity DB 211, the synonym DB 212, the related word DB 213, the category information DB 221, and the related word applicable area DB 222 are in a table format; however, the format is not limited to the table format and other data formats may be employed.

Field structures and field values of a word similarity DB table 300 of the word similarity DB 211, a synonym DB table 400 of the synonym DB 212, a related word DB table 500 of the related word DB 213, a category information DB table 600 of the category information DB 221, a related word applicable area DB table 700 of the related word applicable area DB 222, which will be explained below, are not limited to those described in this embodiment.

FIG. 3 is a diagram illustrating a configuration example of data of the word similarity DB 211. The word similarity DB table 300 which stores the data of the word similarity DB 211 is composed of one or more “word similarity” records as illustrated in FIG. 3. Then, the “word similarity” record is composed of a plurality of fields such as a “first word index,” a “first word text ID,” a “second word index,” a “second word text ID,” “WordNet similarity,” “Word2Vec similarity,” and “completely matched.”

The field “first word index” retains an index of a word generated from the first text input from the user terminal 201. For example, when three sets of words “yesterday,” “in Nagoya,” and “I was” are generated in this order from “kinou nagoya ni imashita (I was in Nagoya yesterday),” the “first word index” of a word similarity record corresponding to “in Nagoya” becomes “2.” The field “first word text ID” retains a value for uniquely identifying the first text input from the user terminal 201.

Furthermore, the field “second word index” retains an index of a word generated from the second text input from the user terminal 201. The field “second word text ID” retains a value for uniquely identifying the second text input from the user terminal 201.

The field “WordNet similarity” retains the similarity based on the distance of the ontology WordNet between the word corresponding to the values of the “first word index” and the “first word text ID” and the word corresponding to the values of the “second word index” and the “second word text ID.” The field “Word2Vec similarity” retains the similarly based on the distance of the word distributed representations Word2Vec between the word corresponding to the values of the “first word index” and the “first word text ID” and the word corresponding to the values of the “second word index” and the “second word text ID.”

Incidentally, the “WordNet similarity” and the “Word2Vec similarity” are examples of the word similarity. The similarity may be normalized. The word similarity DB table 300 may include one field or three or more fields for retaining the word similarity.

The field “completely matched” retains complete match information indicating whether the word corresponding to the values of the “first word index” and the “first word text ID” and the word corresponding to the values of the “second word index” and the “second word text ID” are completely matched or not. The field “completely matched” retains: 1 when the words are completely matched; and 0 when the words are not completely matched.

FIG. 4 is a diagram illustrating a configuration example of data of the synonym DB 212. The synonym DB table 400 which stores the data of the synonym DB 212 is composed of one or more “synonym” records as illustrated in FIG. 4. Then, the “synonym” record is composed of a plurality of fields such as a “target word index,” a “target word text ID,” a “synonym index,” a “synonym text ID,” and a “synonym score.”

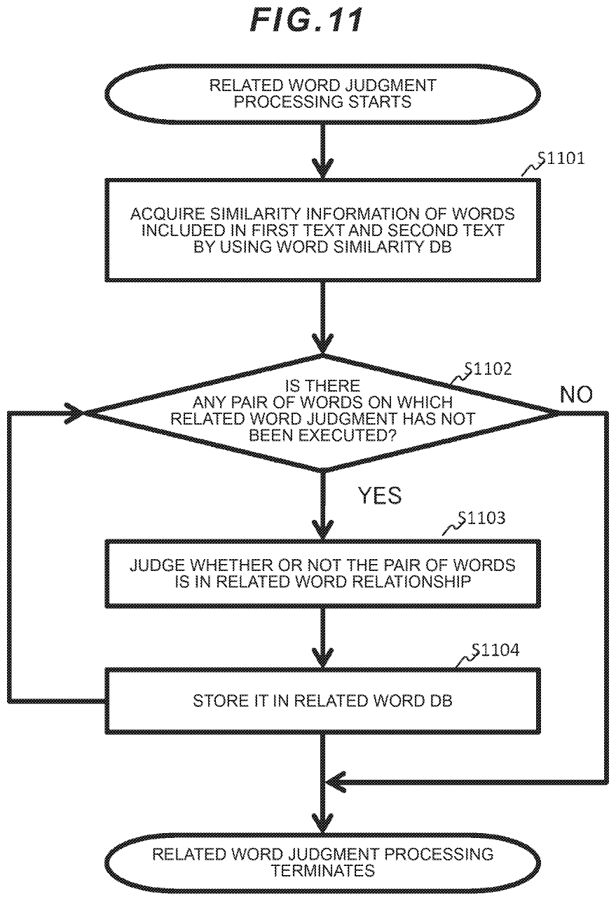

The fields “target word index” and “target word text ID” and the fields “synonym index” and “synonym text ID” retain the indexes and the text ID's of a word pair which is judged as the synonym by synonym judgment processing described later (see FIG. 11) and is retained in the word similarity DB table 300. When the values of the “first word index” and the “first word text ID” of a word generated from the first text are retained in the fields “target word index” and “target word text ID,” the values of the “second word index” and the “second word text ID” of a word generated from the second text are retained in the fields “synonym index” and “synonym text ID.” Similarly, when the values of the “second word index” and the “second word text ID” of the word generated from the second text are retained in the fields “target word index” and “target word text ID,” the values of the “first word index” and the “first word text ID” of the word generated from the first text are retained in the fields “synonym index” and “synonym text ID.”

The field “synonym score” retains information about a degree of synonym relationship between the word corresponding to the values of the “target word index” and the “target word text ID” and the word corresponding to the values of the “synonym index” and the “synonym text ID.”

FIG. 5 is a diagram illustrating a configuration example of data of the related word DB 213. The related word DB table 500 which stores the data of the related word DB 213 is composed of one or more “related word” records as illustrated in FIG. 5. Then, the “related word” record is composed of a plurality of fields such as a “target word index,” a “target word text ID,” a “related word index,” a “related word text ID,” and a “related word score.”

The fields “target word index” and “target word text ID” and the fields “related word index” and “related word text ID” retain the indexes and the text ID's of a word pair which is judged as a related word by related word judgment processing described later (see FIG. 11) and is retained in the word similarity DB table 300. When the values of the “first word index” and the “first word text ID” of a word generated from the first text are retained in the fields “target word index” and “target word text ID,” the values of the “second word index” and the “second word text ID” of a word generated from the second text are retained in the fields “related word index” and “related word text ID.” Similarly, when the values of the “second word index” and the “second word text ID” of the word generated from the second text are retained in the fields “target word index” and “target word text ID,” the values of the “first word index” and the “first word text ID” of the word generated from the first text are retained in the fields “related word index” and “related word text ID.”

The field “related word score” retains information about a degree of related word relationship between the word corresponding to the values of the “target word index” and the “target word text ID” and the word corresponding to the values of the “related word index” and the “related word text ID.”

FIG. 6 is a diagram illustrating a configuration example of data of the category information DB 221. The category information DB table 600 which stores the data of the category information DB 221 is composed of one or more “category information” records as illustrated in FIG. 6. Then, the “category information” record is composed of a plurality of fields such as a “text ID,” a “category type,” a “category value,” a “starting word index,” and an “ending word index.”

The field “text ID” retains a value for uniquely identifying the first text and the second text which are input from the user terminal 201.

The field “category type” retains a category of the category information. For example, the field “category type” retains: a “place” when the relevant “category information” record is the category information about the place; and a “year and month” when the relevant “category information” record is the category information about the year and month.

The field “category value” retains specific content of the category information. The field “category value” can have a plurality of pieces of category information. For example, let us assume that three sets of words “yesterday,” “in Nagoya,” and “I was” are generated in order from one piece of text stating “kinou nagoya ni imashita (I was in Nagoya yesterday).” In this case, the category of “yesterday” is the “year and month” while the category of “in Nagoya” is the “place”; and, therefore, one piece of text can have the plurality of pieces of category information. Accordingly, the category information indicates the category related to the content of the text.

The field “starting word index” retains information about a starting position in the text of the category information identified in the relevant “category information” record. The field “ending word index” retains information about an ending position in the text of the category information identified in the relevant “category information” record. The field “starting word index” and the “ending word index” retain: the value of the “first word index” in the word similarity DB table 300 when the “text ID” is the first text; and the value of the “second word index” in the word similarity DB table 300 when the “text ID” is the second text.

FIG. 7 is a diagram illustrating a configuration example of data of the related word applicable area DB 222. The related word applicable area DB table 700 which stores data of the related word applicable area DB 222 is composed of one or more “related word applicable area” records as illustrated in FIG. 7. Then, the “related word applicable area” record is composed of a plurality of fields such as a “text ID,” a “starting word index,” and an “ending word index.”

The field “text ID” retains a value for uniquely identifying the first text and the second text which are input from the user terminal 201.

The field “starting word index” retains information about a starting position in the text of the related word applicable area identified in the relevant “related word applicable area” record. The field “ending word index” retains information about an ending position in the text of the related word applicable area identified in the relevant “related word applicable area” record. The field “starting word index” and the “ending word index” retain: the value of the “first word index” in the word similarity DB table 300 when the “text ID” is the first text; and the value of the “second word index” in the word similarity DB table 300 when the “text ID” is the second text.

### (5) Processing of Text Analysis System

The operation of the text analysis system 200 will be explained.

### [Entire Text Analysis Processing]

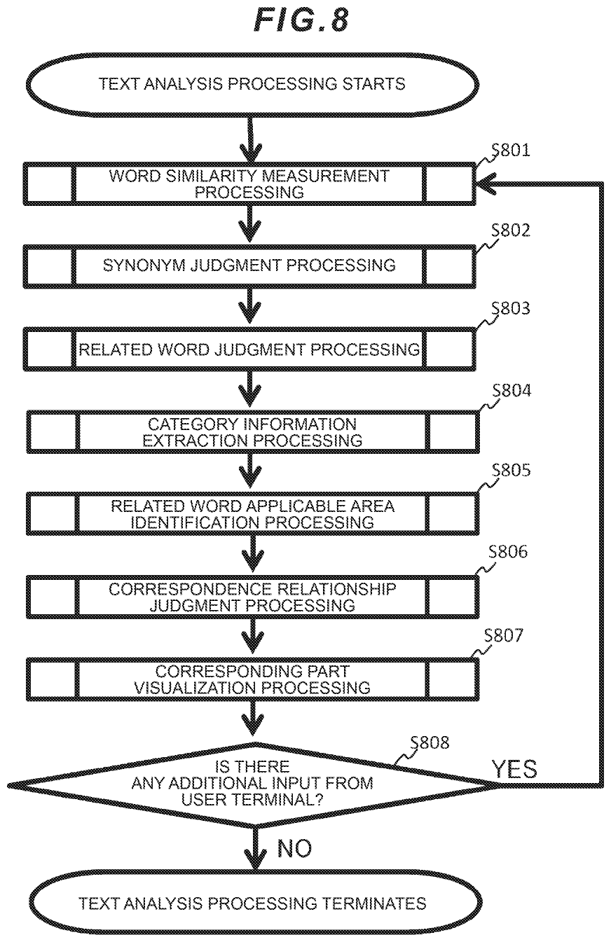

Firstly, the entire flow of the text analysis processing will be explained. FIG. 8 is a flowchart illustrating the entire processing sequence of the text analysis system.

Firstly, in step S801, the text analysis system 200 executes word similarity measurement processing on the first text and the second text which are input from the user terminal 201. Next, in step S802, the text analysis system 200 performs the synonym judgment by using the word similarity information measured in step S801. Then, in step S803, the text analysis system 200 performs the related word judgment by using the word similarity information measured in step S801.

Subsequently, in step S804, the text analysis system 200 receives the input accepted from the user terminal 201 and extracts the category information. Next, in step S805, the text analysis system 200 identifies the related word applicable area by using the category information extracted in step S804. Then, in step S806, the text analysis system 200 executes correspondence relationship judgment processing. Subsequently, in step S807, the text analysis system 200 executes processing for visualizing a corresponding part between the first text and the second text.

Lastly, in step S808, the text analysis system 200 judges whether additional text is input from the user terminal 201 or not. If the additional text is input (step S808: YES), the text analysis system 200 returns to the processing in step S801. On the other hand, if the additional text is not input (step S808: NO), the text analysis system 200 terminates this text analysis processing.

### [Word Similarity Measurement Processing]

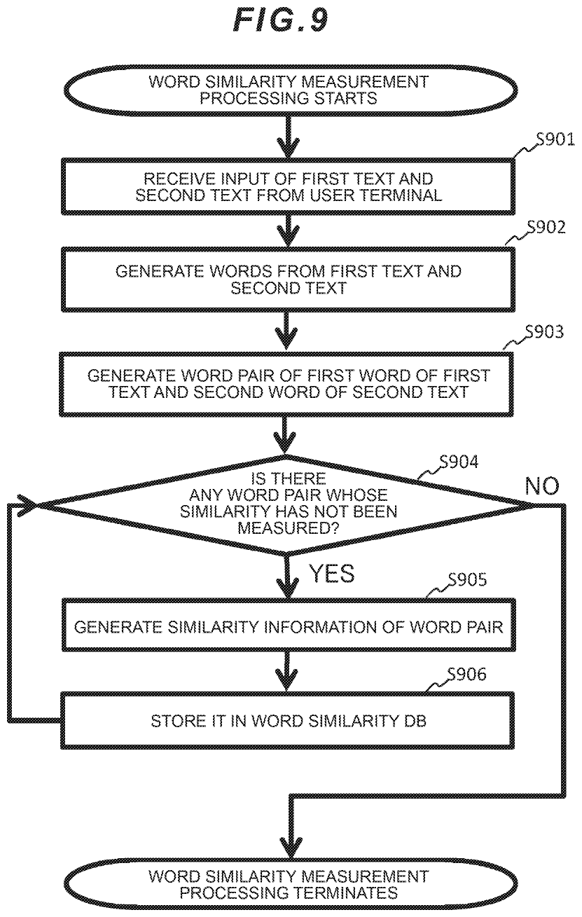

FIG. 9 is a flowchart illustrating a word similarity measurement processing sequence. The word similarity measurement processing is the detailed processing of step S801 illustrated in FIG. 8 and is executed by the word similarity measurement unit 231.

Firstly, in step S901, the word similarity measurement unit 231 receives the first text and the second text which are input from the user terminal 201. Next, in step S902, the word similarity measurement unit 231 generates words from the first text and the second text.

Then, in step S903, the word similarity measurement unit 231 generates all combinations of word pairs, each of which is generated by combining one first word generated from the first text generated in step S902 and one second word generated from the second text. Subsequently, in step S904, the word similarity measurement unit 231 judges whether any word pair whose similarity has not been measured exists or not among all the combinations of the word pairs generated in step S903. If the word pair whose similarity has not been measured exists (step S904: YES), the word similarity measurement unit 231 proceeds to the processing in step S905; and if the similarity of all the word pairs has been measured (step S904: NO), the word similarity measurement unit 231 terminates this word similarity measurement processing.

In step S905, the word similarity measurement unit 231 generates the similarity information of the word pair whose similarity has not been measured, and the complete match information indicating whether or not the words of the word pair are completely matched. Next, in step S906, the word similarity measurement unit 231 associates the similarity information and the complete match information, which were generated in step S905, with the first word index, the first word text ID, the second word index, and the second word text ID and stores them in the word similarity DB 211. After step S906 terminates, the word similarity measurement unit 231 proceeds to the processing in step S904. Regarding a method for generating the similarity information in step S905, there are a method for measuring the distance of the word pair in the WordNet (WordNet similarity) and a method for measuring the difference in the word distributed representations (Word2Vec similarity); however, the method for generating the similarity information is not limited to these methods.

### [Synonym Judgment Processing]

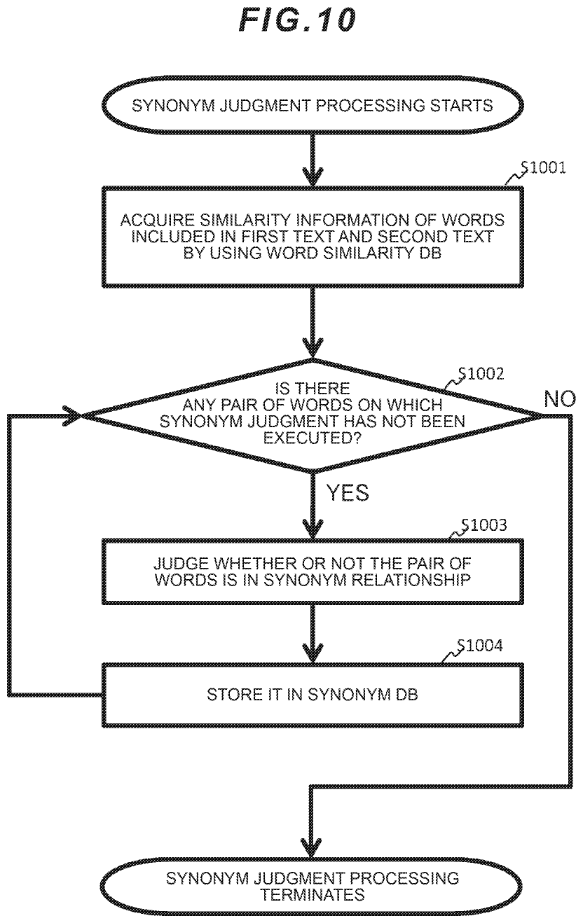

FIG. 10 is a flowchart illustrating a synonym judgment processing sequence. The synonym judgment processing is the detailed processing of step S802 illustrated in FIG. 8 and is executed by the synonym judgment unit 232.

Firstly, in step S1001, the synonym judgment unit 232 acquires the similarity information of the word pair obtained from the first text and the second text by using the word similarity DB 211. Next, in step S1002, the synonym judgment unit 232 judges whether any word pair on which the synonym judgment processing has not been executed exists or not among the similarity information acquired in step S1001. If the word pair on which the synonym judgment processing has not been executed exists (step S1002: YES), the synonym judgment unit 232 proceeds to the processing of step S1003; and if the synonym judgment has been executed on all the word pairs (step S1002: NO), the synonym judgment unit 232 terminates this synonym judgment processing.

In step S1003, the synonym judgment unit 232 executes the synonym judgment processing on the word pair on which the synonym judgment processing has not been executed. As an example of the method for judging the synonym in step S1003, there is a method for the synonym judgment unit 232 to judge that the relevant word pair is a synonym when the sum of the values of the field “WordNet similarity” and the field “Word2Vec similarity” in the word similarity DB table 300 is equal to or more than a specified threshold value (for example, 1). However, the method for judging the synonym is not limited to this example. In step S1003, the synonym judgment unit 232 also calculates the synonym score for the word pair judged as the synonym. The synonym score is, for example, the sum of the “WordNet similarity” and the “Word2Vec similarity.”

Next, in step S1004, the synonym judgment unit 232 stores the judgment results including the word indexes, the text ID's, and the synonym score of the word pair, which was judged as the synonym by the judgment in step S1003, in the synonym DB 212. When step S1004 terminates, the synonym judgment unit 232 returns to the processing in step S1002.

### [Related Word Judgment Processing]

FIG. 11 is a flowchart illustrating a related word judgment processing sequence. The related word judgment processing is the detailed processing of step S803 illustrated in FIG. 8 and is executed by the related word judgment unit 233.

Firstly, in step S1101, the related word judgment unit 233 acquires the similarity information of the word pair obtained from the first text and the second text by using the word similarity DB 211. Next, in step S1102, the related word judgment unit 233 judges whether any word pair on which the related word judgment processing has not been executed exists or not among the similarity information acquired in step S1101. If the word pair on which the related word judgment has not been executed exists (step S1102: YES), the related word judgment unit 233 proceeds to the processing of step S1103; and if the related word judgment has been executed on all the word pairs (step S1102: NO), the related word judgment unit 233 terminates this related word judgment processing.

In step S1103, the related word judgment unit 233 executes the related word judgment on the word pair on which the related word judgment processing has been executed. In step S1103, as an example of the method for judging the related word, there is a method for the related word judgment unit 233 to judge that the relevant word pair is a related word when the sum of the values of the field “WordNet similarity” and the field “WordVec similarity” in the word similarity DB table 300 is less than a specified threshold value (for example, 1). However, the method for judging the related word is not limited to this example. In step S1103, the related word judgment unit 233 also calculates the related word score for the word pair judged as the related word. The related word score is, for example, a value obtained by assigning a minus sign to the sum of the “WordNet similarity” and the “Word2Vec similarity.”

Next, in step S1104, the related word judgment unit 233 stores the judgment results including the word indexes, the text ID's, and the related word score of the word pair, which was judged as the related word in step S1103, in the related word DB 213. When step S1104 terminates, the related word judgment unit 233 returns the processing to step S1102.

### [Category Information Extraction Processing]

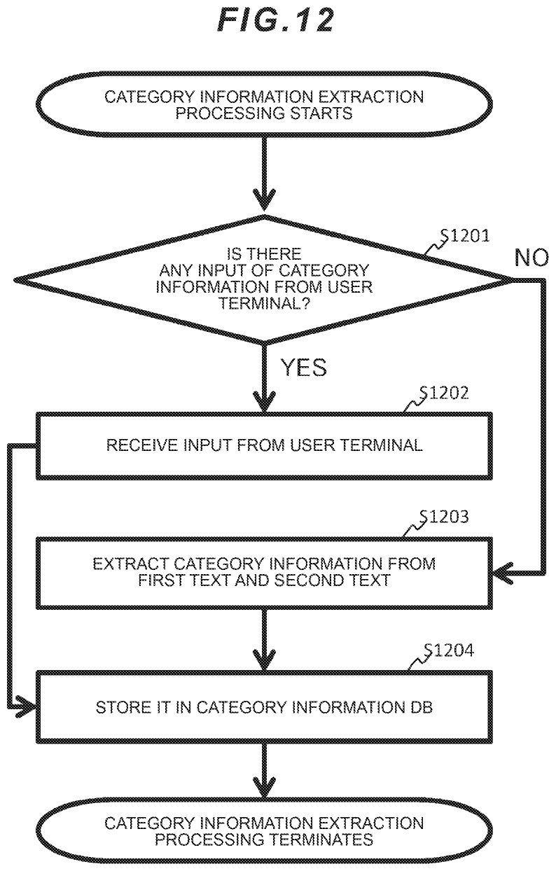

FIG. 12 is a flowchart illustrating a category information extraction processing sequence. The category information extraction processing is the detailed processing of step S804 illustrated in FIG. 8 and is executed by the category information extraction unit 234.

Firstly, in step S1201, the category information extraction unit 234 judges whether the category information is input from the user terminal 201 or not. If the category information is input (step S1201: YES), the category information extraction unit 234 proceeds to the processing of step S1202; and if the category information is not input (step S1201: NO), the category information extraction unit 234 proceeds to the processing of step S1203.

In step S1202, the category information extraction unit 234 receives the category information which has been input from the user terminal 201. When step S1202 terminates, the category information extraction unit 234 proceeds to the processing of step S1204.

In step S1203, the category information extraction unit 234 extracts the category information from the first text and the second text. Next, in step S1204, the category information extraction unit 234 stores the category information, which was received in step S1202 or extracted in step S1203, in the category information DB 221.

A specific example of the category information will be explained. For example, a case will be examined where the first text of the text ID: 1 is “kinou nagoya ni imashita (I was in Nagoya yesterday); kyou wa toukyou ni imasu (I am in Tokyo today).” In this case, the first word indexes are “yesterday: 1,” “in Nagoya: 2,” “I was: 3,” “today: 4,” “in Tokyo: 5,” and “I am: 6.” As an example of rules for generating the category information from such first text, there is a method of generating a “category information” record where the field “text ID” is “1”, the field “category type” is the “place,” the field “category value” is “in Nagoya,” the field “starting word index” is “1,” and the field “ending word index” is “3.” In this example, the first sentence including “Nagoya” from among the two sentences “kinou nagoya ni imashita (I was in Nagoya yesterday)” and “kyou wa toukyou ni imasu (I am in Tokyo today)” is set as an area corresponding to the “category value” “Nagoya.” However, the category information and its generation method are not limited to this example.

### [Related Word Applicable Area Identification Processing]

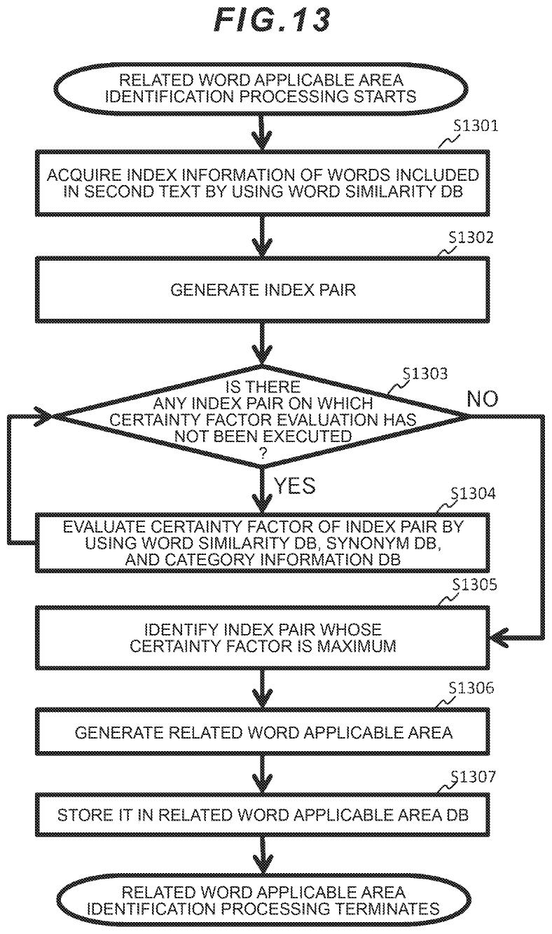

FIG. 13 is a flowchart illustrating a related word applicable area identification processing sequence. The related word applicable area identification processing is the detailed processing of step S805 illustrated in FIG. 8 and is executed by the related word applicable area identification unit 235.

Firstly, in step S1301, the related word applicable area identification unit 235 acquires the index information of the words included in the second text by using the word similarity DB 211. Next, in step S1302, the related word applicable area identification unit 235 generates a pair of indexes (hereinafter referred to as the “index pair”) from the index information acquired in step S1301.

Under this circumstance, for example, when “1,” “2,” and “3” are acquired as the second word indexes, the “index pair” indicates a combination of indexes where the latter index is a larger value than the former index such as “1” and “2,” “1” and “3,” or “2” and “3.” All patterns of a partial area relative to the entire area of the text can be expressed using such a combination of a starting index and an ending index. However, the “index pair” is not limited to this example. For example, the “index pair” may include only one index like “1” as its element.

Next, in step S1303, the related word applicable area identification unit 235 judges when any index pair on which the certainty factor evaluation has not been executed exists or not among all the “index pairs” generated in step S1302. If the index pair on which the certainty factor evaluation has not been executed exists (step S1303: YES), the related word applicable area identification unit 235 proceeds to the processing of step S1304; and if the certainty factor evaluation has been executed on all the index pairs (step S1303: NO), the related word applicable area identification unit 235 proceeds to the processing of step S1305.

In step S1304, the related word applicable area identification unit 235 evaluates the certainty factor of the index pair by using the word similarity DB 211, the synonym DB 212, and the category information DB 221. When step S1304 terminates, the related word applicable area identification unit 235 returns to the processing of step S1303. The related word applicable area can be identified with good precision by using the category information DB 221.

An example of the certainty factor evaluation method in step S1304 is as follows. For example, a case will be examined where the index pair of one piece of the second text generated in step S1302 is “3” and “5” and the first word indexes “1” to “2” of the first text are acquired by using the word similarity DB 211. Specifically speaking, a case will be examined where the first text is composed of words with the first word indexes “1” and “2” and the second text is composed of words with the second word indexes “3,” “4,” and “5.”

Under this circumstance, let us assume that regarding the word with the first word index “2” in the first text and the word with the second word index “4” in the second text, the category information of both the words is the “category type” “place” and the “category value” “Nagoya” with reference to the category information DB 221. Therefore, their category information matches, so the category score=1 is set. On the other hand, when the words whose category information matches do not exist, the category score=0 is set. When there are a plurality of pieces of category information that match, the category score is obtained, for example, by calculating the sum of these values. Under this circumstance, the category score is not limited to the sum and may be other calculated values such as a product or various kinds of statistic values.

Furthermore, let us assume that the synonym score of the word with the second word index “3” in the second text and the word with the first word index “1” in the first text is 1.5 with reference to the synonym DB 212. If a plurality of “synonym” records which are combinations of the second word index of the second text and the first word index of the first text exist in the synonym DB 212, the synonym score is obtained by calculating the sum of these values. Under this circumstance as well, the synonym score is not limited to the sum and may be other calculated values such as a product or various kinds of statistic values such as a maximum value.

Therefore, for example, the certainty factor of the index pair “3” and “5” of the second text is evaluated as the category score+the synonym score=1+1.5=2.5The certainty factor is not limited to the simple sum of the respective scores and may be a specified weighted sum of the respective scores or various kinds of statistic values.

Incidentally, the category score is not indispensable for the above-mentioned certainty factor. Furthermore, the above-mentioned certainty factor may include the complete match information between the word corresponding to the first word index and the word corresponding to the second word index. The certainty factor in this case is not limited to the simple sum of the respective scores and may be a specified weighted sum of the respective scores or various kinds of statistic values. The synonym score is complemented and the precision of the certainty factor is enhanced by including the complete match information in the certainty factor.

In step S1305, the related word applicable area identification unit 235 identifies the index pair whose certainty factor evaluated by the repeated processing in step S1303 and S1304 becomes maximum. Next, in step S1306, the related word applicable area identification unit 235 generates the “related word applicable area” based on the index pair identified in step S1305 and identifies its “starting index” and “ending index.”

In step S1306, for example, when the index pair is “3” and “4,” the related word applicable area identification unit 235 subtracts a specified value (for example, 2) from the value of the word index “3” and adds a specified value (for example, 2) to the word index “4,” thereby generating the “related word applicable area” where the “starting index” is “1” and the “ending index” is “6.” However, the “related word applicable area” is not limited to this example and may be generated by adding or subtracting one or more constitutional units of text such as a phrase(s), sentence(s), paragraph(s), clause(s), or a line break(s).

Lastly, in step S1307, the related word applicable area identification unit 235 stores the “starting index” and the “ending index” of the “related word applicable area” generated in step S1306, together with the text ID of the second text from which the “related word applicable area” was generated, in the related word applicable area DB table 700 of the related word applicable area DB 222.

### [Correspondence Relationship Judgment Processing]

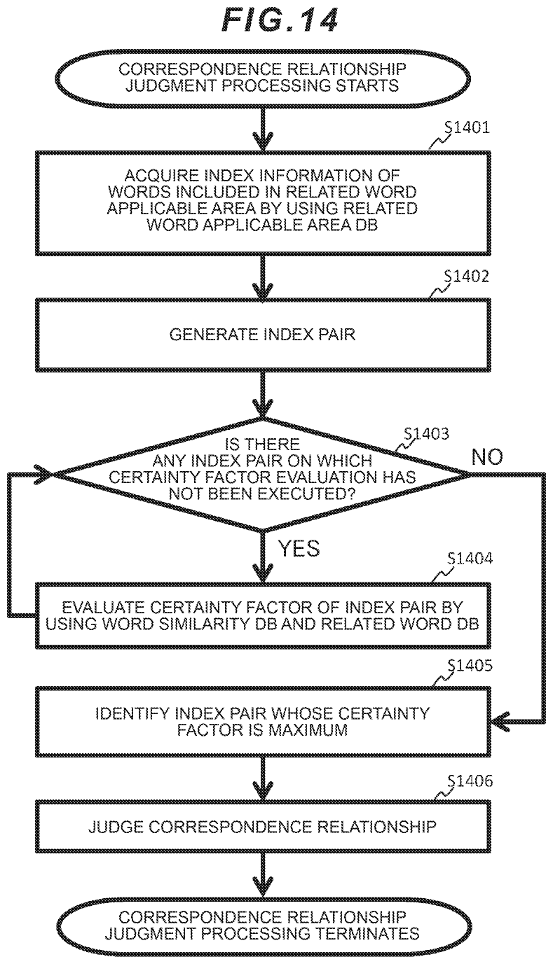

FIG. 14 is a flowchart illustrating a processing sequence for judging the correspondence relationship between the first text and the second text. The processing for judging the correspondence relationship between the first text and the second text is the detailed processing of step S806 illustrated in FIG. 8 and is executed by the text correspondence relationship judgment unit 236.

Firstly, in step S1401, the text correspondence relationship judgment unit 236 acquires the “starting index” and the “ending index” of the related word applicable area by using the related word applicable area DB 222. Next, in step S1402, the text correspondence relationship judgment unit 236 generates the “index pair” from the index information acquired in step S1401.

Under this circumstance, for example, when the filed “starting index” is “1” and the field “ending index” is “3,” the “index pair” indicates a combination of indexes where the latter index is a larger value than the former index such as “1” and “2,” “1” and “3,” or “2” and “3” and it is the combination of the indexes “1” or more and “3” or less. However, the “index pair” here is not limited to this example. For example, the “index pair” may include only one index as its element.

Next, in step S1403, the text correspondence relationship judgment unit 236 judges whether any index pair on which the certainty factor evaluation has not been executed exists or not among all the “index pairs” generated in step S1402. If the index pair on which the certainty factor evaluation has not been executed exists (step S1403: YES), the text correspondence relationship judgment unit 236 proceeds to the processing of step S1404; and if the certainty factor evaluation has been executed on all the index pairs (step S1403: NO), the text correspondence relationship judgment unit 236 returns to the processing of step S1405.

In step S1404, the text correspondence relationship judgment unit 236 evaluates the certainty factor of the index pair by using the word similarity DB 211 and the related word DB 213. When step S1404 terminates, the text correspondence relationship judgment unit 236 returns to the processing of step S1403.

An example of the certainty factor evaluation method in step S1404 is as follows. For example, a case will be examined where the index pair of one related word applicable area generated in step S1402 is “3” and “5” and the first word indexes “1” to “2” of the first text are acquired by using the word similarity DB 211. Specifically speaking, a case will be examined where the first text is composed of words with the first word indexes “1” and “2” and the second text is composed of words with the second word indexes “3,” “4,” and “5.”

Under this circumstance, let us assume that the related word score for the word with the second word index “3” in the second text and the word with the first word index “1” in the first text is (−0.5) with reference to the related word DB 213. When a plurality of “related word” records, each of which is a combination of the second word index of the second text and the first word index of the first text, exist in the related word DB 213, the related word score is obtained, for example, by calculating the sum of these values. Under this circumstance as well, the related word score is not limited to the sum and may be other calculated values such as a product or various kinds of statistic values such as a maximum value.

Therefore, for example, the certainty factor of the index pair “3” and “5” of the second text is evaluated as the certainty factor=the related word score=−0.5.

Incidentally, the category score based on the category information DB 221 may be used when calculating the certainty factor. The certainty factor in this case is not limited to the simple sum of the respective scores and may be a specified weighted sum of the respective scores or various kinds of statistic values. Furthermore, the certainty factor may include the complete match information between the word corresponding to the first word index and the word corresponding to the second word index. The certainty factor in this case is not limited to the simple sum of the respective scores and may be a specified weighted sum of the respective scores or various kinds of statistic values. The related word score is complemented and the precision of the certainty factor is enhanced by including the complete match information in the certainty factor.

In step S1405, the text correspondence relationship judgment unit 236: identifies the index pair whose certainty factor evaluated by the repeated processing in step S1403 and S1404 becomes maximum; and sets the identified index pair as the “starting index” and the “ending index” of the “corresponding part.”

Lastly, in step S1406, the text correspondence relationship judgment unit 236 evaluates the correspondence relationship between the “corresponding part” in the second text based on the “starting index” and the “ending index” identified in step S1405 and the first text. For example, if the certainty factor of the index pair which was identified as maximum in step S1405 is equal to or more than a specified threshold value, the text correspondence relationship judgment unit 236 judges that the first text and the “corresponding part” in the second text have the correspondence relationship; and if the certainty factor of the index pair is less than the specified threshold value, the text correspondence relationship judgment unit 236 judges that the first text and the “corresponding part” in the second text do not have the correspondence relationship.

### [Corresponding Part Visualization Processing]

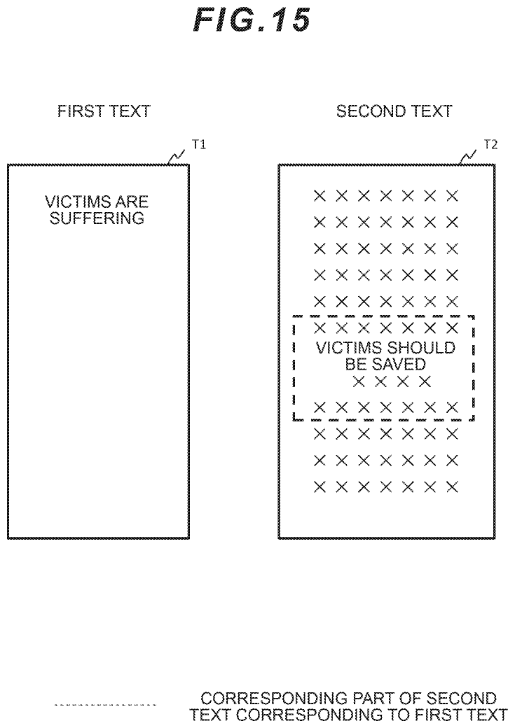

FIG. 15 is a diagram illustrating the result of the corresponding part visualization processing. The corresponding part visualization processing is the detailed processing of step S807 illustrated in FIG. 8 and is executed by the corresponding part visualization unit 240. As illustrated in FIG. 8, for example, the corresponding part visualization unit 240 may display first text T1 and second text T2 side by side on a specified display screen and display the “corresponding part” in the second text, which is judged as having the correspondence relationship with the first text T1 so that the “corresponding part” can be identified. By displaying it in this manner, it becomes possible to easily identify the corresponding part, which corresponds to the first text T1, in the second text T2.

In the above-mentioned embodiment, when searching the second text and judging the corresponding part with the first text, the synonym is firstly used to search the second text and a specified range which is based on, and covers, a matched area obtained by the search is set as the related word applicable area, which is then is searched by using the related word. Accordingly, the related word extracted by using the ontology and the word distributed representations is applied locally to the related word applicable area based on the matched area which may highly possibly be the corresponding part. Specifically speaking, since the related word obtained from the first text and the second text is limited to be used for the related word applicable area which has low possibility of including noises, it is possible to avoid the influence on degradation of the corresponding part judgment precision by the noises and achieve the effect of improving the precision by means of the related word.

### Other Embodiments

(1) In the above-mentioned embodiment, one type is used regarding each of the “synonym” and the “related word” for classifying the “word pairs.” However, without limitation to this example, a plurality of types with different judgment threshold values may be provided for each of the “synonym” and the “related word.”

For example, let us assume that the “synonym” include “synonym I” and “synonym II” and the “related word” include “related word I” and “related word II.” Then, when extracting the corresponding part which corresponds to the “first text” from the “second text,” either types of the “synonym” and the “related word” are combined as appropriate and the related word applicable area identification processing (see FIG. 13) and the correspondence relationship judgment processing (see FIG. 14) are executed. As a result, for example, it is possible to extract a plurality of candidates as the corresponding part, which corresponds to the “first text,” in the “second text” and select the optimum corresponding part from the plurality of candidates.

(2) In the above-mentioned embodiment, the correspondence relationship indicating which area of the “related word applicable area” in the “second text” corresponds to the “first text” is judged. However, without limitation to this example, it is also possible to acquire the first word index to cover patterns of all partial areas of the “first text,” and to extract a corresponding part(s) in the “second text” having the correspondence relationship with each partial area of the “first text.” As a result, it is possible to extract the corresponding part(s) with respect to each partial area of the “first text” and the “second text.”

Although the present disclosure has been described with reference to example embodiments, those skilled in the art will recognize that various changes and modifications may be made in form and detail without departing from the spirit and scope of the claimed subject matter. For example, the aforementioned embodiments have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment. Also, regarding part of the configuration of each embodiment, it is possible to add, delete, replace, integrate, or distribute the configuration. Furthermore, each configuration and each processing illustrated in the embodiments may be distributed or integrated as appropriate based on processing efficiency or implementation efficiency.

What is claimed is:

1. A text analysis method performed by a text analysis system, comprising:
a measurement step of generating constitutional units of text obtained from each of first text and second text by executing element decomposition processing, and measuring similarity of each constitutional unit pair between the constitutional units of the first text and the constitutional units of the second text;
a synonym or related-word judgment step of judging whether each constitutional unit pair is either a synonym with the similarity equal to or more than a specified value or a related word with the similarity less than the specified value;
an identification step of identifying a related word applicable area to which the related word is to be applied from the second text, on the basis of the synonym judged by the synonym or related-word judgment step; and
a correspondence relationship judgment step of judging a correspondence relationship between the related word applicable area and the first text on the basis of the related word judged by the synonym or related-word judgment step.

2. The text analysis method according to claim 1,
wherein in the measurement step, a plurality of types of similarities are measured with respect to each constitutional unit pair; and
wherein in the synonym or related-word judgment step, whether each constitutional unit pair is either the synonym or the related word is judged on the basis of the plurality of types of similarities.

3. The text analysis method according to claim 1,
wherein in the identification step, a partial area whose certainty factor based on the similarity corresponding to the synonym with respect to the first text is maximum is identified among partial areas of all patterns of the second text and the related word applicable area is generated by expanding the identified partial area for only a specified range.

4. The text analysis method according to claim 3,
wherein in the identification step, the certainty factor is further based on information about whether category information indicating a category related to text content matches or not between the partial areas of all patterns of the second text and the first text.

5. The text analysis method according to claim 3,
wherein in the identification step, the certainty factor is further based on information about whether the constitutional units of each constitutional unit pair are identical to each other.

6. The text analysis method according to claim 1,
wherein in the correspondence relationship judgment step, a partial area whose certainty factor based on the similarity corresponding to the related word with respect to the first text is maximum is identified among partial areas of all patterns of the related word applicable area and the correspondence relationship between the identified partial area and the first text is judged.

7. The text analysis method according to claim 6,
wherein in the correspondence relationship judgment step, the certainty factor is further based on information about whether category information indicating a category related to text content matches between the partial areas of all patterns of the second text and the first text.

8. The text analysis method according to claim 6,
wherein in the correspondence relationship judgment step, the certainty factor is further based on information about whether the constitutional units of each constitutional unit pair are identical to each other.

9. The text analysis method according to claim 1,
further comprising a visualization step of outputting and visualizing a corresponding part between the first text and the second text to a corresponding part visualization unit on the basis of a judgment result of the correspondence relationship by the correspondence relationship judgment step.

10. A non-transitory computer-readable recording medium for storing a text analysis program for causing a computer function as a text analysis system for performing text analysis,
the computer being caused to function as:
a measurement unit that generates constitutional units of text obtained from each of first text and second text by executing element decomposition processing, and measures similarity of each constitutional unit pair between the constitutional units of the first text and the constitutional units of the second text;
a synonym or related-word judgment unit that judges whether each constitutional unit pair is either a synonym with the similarity equal to or more than a specified value or a related word with the similarity less than the specified value;
an identification unit that identifies a related word applicable area to which the related word is to be applied from the second text, on the basis of the synonym judged by the synonym or related-word judgment unit; and
a correspondence relationship judgment unit that judges a correspondence relationship between the related word applicable area and the first text on the basis of the related word judged by the synonym or related-word judgment unit.

11. A text analysis system for performing text analysis, comprising:
a measurement unit that generates constitutional units of text obtained from each of first text and second text by executing element decomposition processing, and measures similarity of each constitutional unit pair between the constitutional units of the first text and the constitutional units of the second text;
a synonym or related-word judgment unit that judges whether each constitutional unit pair is either a synonym with the similarity equal to or more than a specified value or a related word with the similarity less than the specified value;
an identification unit that identifies a related word applicable area to which the related word is to be applied from the second text, on the basis of the synonym judged by the synonym or related-word judgment unit; and
a correspondence relationship judgment unit that judges a correspondence relationship between the related word applicable area and the first text on the basis of the related word judged by the synonym or related-word judgment unit.
